(19) United States
(12) Patent Application Publication
(10) Pub. No.: US 2022/0406207 A1
(43) Pub. Date: Dec. 22, 2022

(54) SYSTEMS AND METHODS FOR OBJECTIVE-BASED SKILL TRAINING

(71) Applicant: Pearson Education, Inc., Bloomington, MN (US)

(72) Inventors: Matthew CELANO, Orlando, FL (US); William GRIECO, Bridgewater, NJ (US); Matthew GOBLE, Superior, CO (US); Ying XU, Bloomington, MN (US); Carol BOWERS, Bloomington, MN (US); Eric BASSETT, Bloomington, MN (US)

(21) Appl. No.: 17/769,996

(22) PCT Filed: Nov. 5, 2020
(86) PCT No.: PCT/US2020/059099

§ 371 Date: Apr. 18, 2022

Related U.S. Application Data
(60) Provisional application No. 62/931,018, filed on Nov. 5, 2019.

(51) Int. Cl. G09B 5/02

(52) U.S. Cl. CPC G09B 5/02; G09B 5/06

(57) ABSTRACT

Systems and methods of the present invention provide for determining a required skill set for meeting a goal, determining the current skill set of a user, identifying skill gaps between the required skill set and the user's current skill set, assigning skill training objectives to the user corresponding to the skill gaps, monitoring progress of the user through completion of the skill training objectives, and alerting the user upon completion of the skill training objectives. Goals and skill training objectives may be set for multiple users to close skill gaps preventing such users from qualifying for roles of a project to which the users are closely matched. The each user's respective skill training objective progress may be monitored and tracked provided via a user interface at a manager device associated with the project. The manager device may be alerted when the skill training objectives have been completed by the users.

### CROSS-REFERENCE TO RELATED APPLICATION

This application claims the benefit of priority from Provisional Application No. 62/931,018, filed under the same title on Nov. 5, 2019, the entire contents of which is incorporated herein by reference.

### FIELD OF THE INVENTION

This disclosure relates to the field of systems and methods configured to identify the skills of a candidate, generate and deliver one or more courses for skill development to the candidate, and/or provide certification or other credentials for skills obtained by the candidate via the courses.

### BACKGROUND

A computer network or data network is a telecommunications network which allows computers to exchange data. In computer networks, networked computing devices exchange data with each other along network links (data connections). The connections between nodes are established using either cable media or wireless media.

Network computer devices that originate, route and terminate the data are called network nodes. Nodes can include hosts such as personal computers, phones, servers as well as networking hardware. Two such devices can be said to be networked together when one device is able to exchange information with the other device, whether or not they have a direct connection to each other.

Computer networks differ in the transmission media used to carry their signals, the communications protocols to organize network traffic, the network's size, topology and organizational intent. In most cases, communications protocols are layered on other more specific or more general communications protocols, except for the physical layer that directly deals with the transmission media.

### BRIEF DESCRIPTION OF THE DRAWINGS

FIG. 1 illustrates a system level block diagram showing data stores, data centers, servers, and clients of a distributed computing environment, in accordance with various embodiments.

FIG. 2 illustrates a system level block diagram showing physical and logical components of a special-purpose computer device within a distributed computing environment, in accordance with various embodiments.

FIG. 3A illustrates a system by which course content can be recommended to and delivered to users, which may be selected to meet the goals of the users, in accordance with various embodiments.

FIG. 3B illustrates various data stores that may be included in data store servers of FIG. 3A, in accordance with various embodiments.

FIG. 4A illustrates a process flow for a method of identifying skill gaps for a user, generating skill training objectives for filling the skill gaps, and monitoring user progress toward completing the skill training objectives, in accordance with an embodiment.

FIG. 4B illustrates a process flow for a method of building a user profile, in accordance with an embodiment.

FIG. 5 illustrates a process flow for a method of skill-based matching of employees to a project, generating skill training objectives for employees based on identified skill gaps, and monitoring employee progress toward completing the skill training objectives, in accordance with an embodiment.

FIG. 6 shows an illustrative screen of a user interface that may be displayed to a manager via a manager device and that includes metrics related to skill training objectives and skill gaps of employees associated with the manager, in accordance with an embodiment.

FIG. 7 shows an illustrative screen of a user interface that may be displayed to a user via a user device and that includes metrics related to skill training objectives and skill gaps of that employee, in accordance with an embodiment.

FIG. 8 shows an illustrative screen of a user interface that may be displayed to a user via a user device and that includes a career path for the user and a listing of skills of the user's skill set, in accordance with an embodiment.

FIG. 9 shows an illustrative screen of a user interface that may be displayed to a manager via a manager device and that includes a listing of projects associated with that manager and recommendations for filling an unfilled role of a project, in accordance with an embodiment.

FIG. 10A shows an illustrative screen of a user interface for receiving user input selecting an area of study for use in a recommendation engine, in accordance with an embodiment.

FIG. 10B shows an illustrative screen of a user interface for determining financial preferences for use in a recommendation engine, in accordance with an embodiment.

FIG. 10C shows an illustrative screen of a user interface for receiving user input identifying a user's current career/role for use in a recommendation engine, in accordance with an embodiment.

FIG. 10D shows an illustrative screen of a user interface for receiving user input identifying a user's career goals for use in a recommendation engine, in accordance with an embodiment.

FIG. 10E shows an illustrative screen of a user interface for identifying user recommendations for use in a recommendation engine, in accordance with an embodiment.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

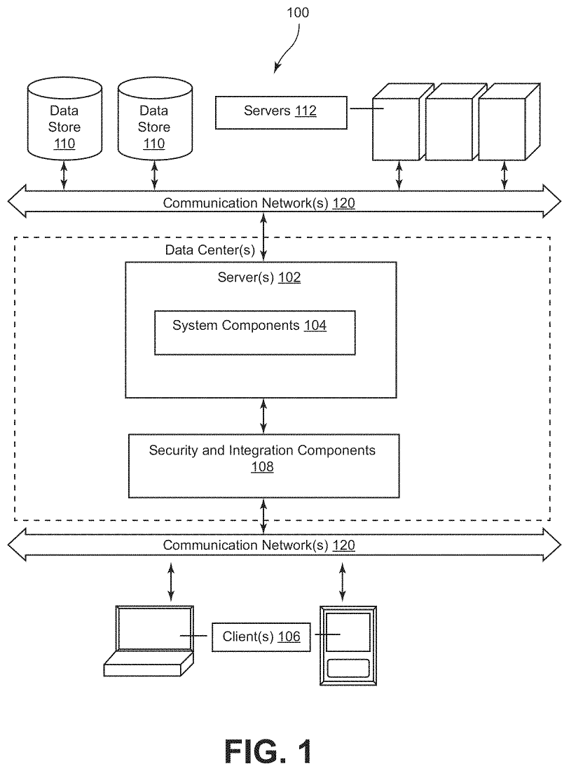

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

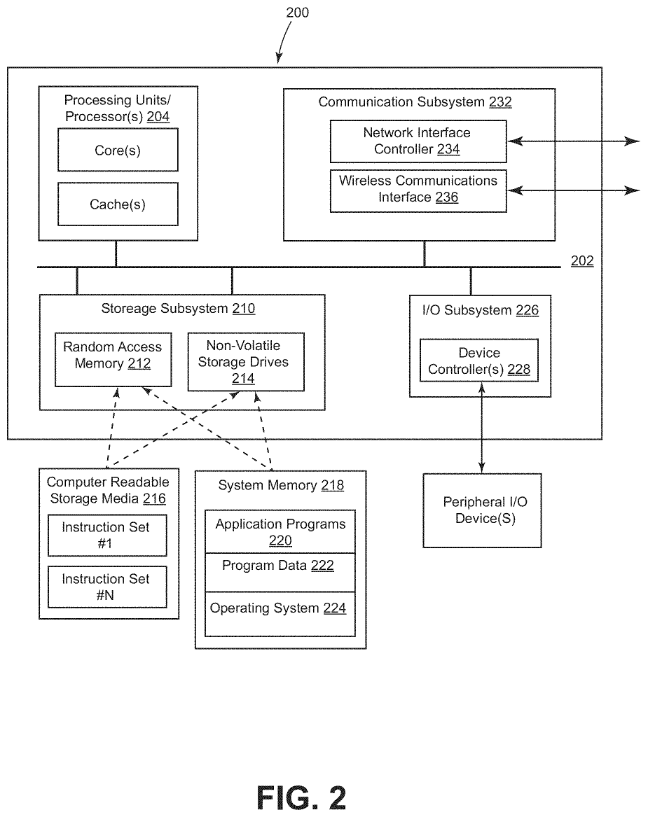

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

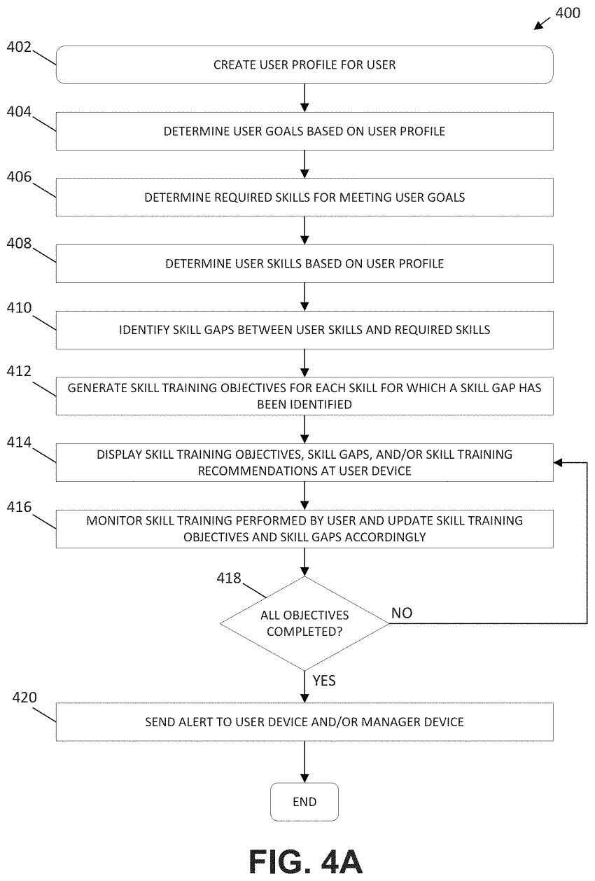

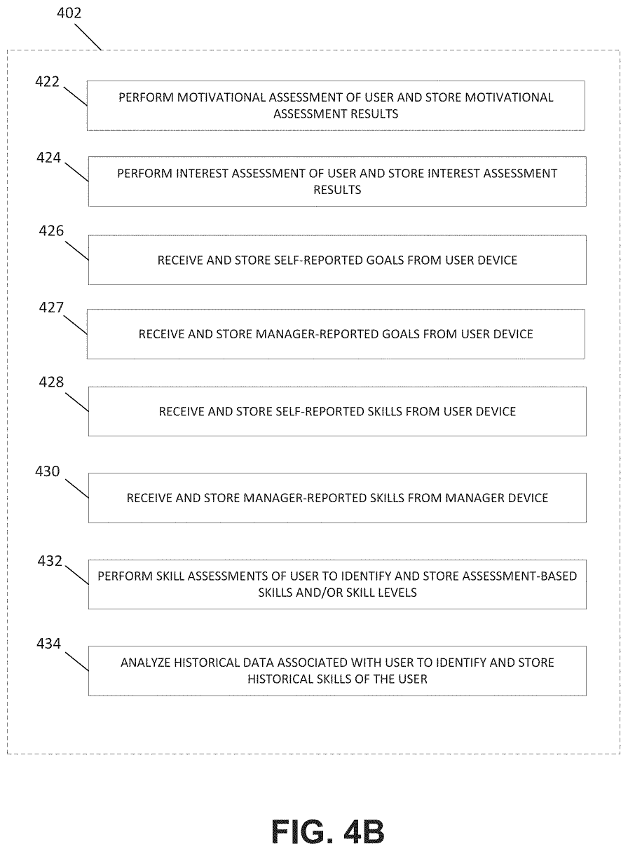

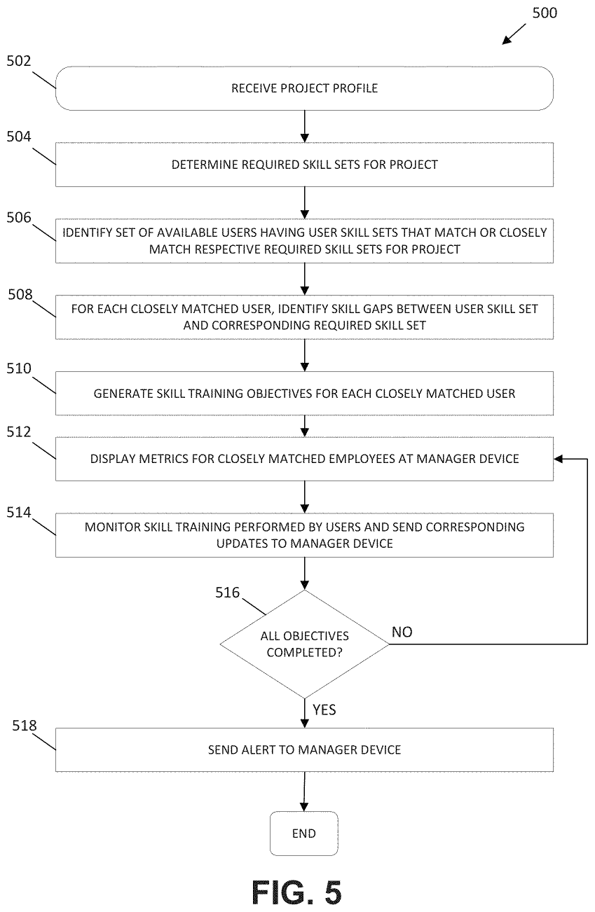

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210. For example, the storage subsystem 210 may include any or all source code, object code, executable code, databases, algorithms, methods, processes, user experience (UX) design elements, application programming interfaces, and the like used in the execution of tasks by the system 200 (e.g., execution of methods 400, 500, FIGS. 4A, 5).

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

There is presently a need, possessed both by both employees and their managers, to identify areas (e.g., skills) in which individual employees should receive training in order to meet defined goals. In some cases, it may not be clear to the employee or manager in question which specific skills are needed to achieve these goals.

From an employee's perspective, such defined goals may include obtaining a higher role within their organization, where the employee may lack the skills that are prerequisites for being placed in that role. In some cases, the employee may need to be promoted to one or more intermediate roles in order to progress to their ultimately desired role, and each of these intermediate roles may require their own wholly or partially unique skill sets, which may include skills that are not possessed by the employee. The difference between the skills an employee possesses and the skills needed for the employee to achieve a given goal (including goals related to meeting requirements of roles for a project, as will be described) are referred to herein as a “skill gap”. In order to fill this skill gap, an employee may need to undergo training according to one or more skill training objectives. For example, each skill training objective associated with a given skill gap may represent a respective skill in which the employee requires training to fill the skill gap. In some embodiments, a skill training objective may include multiple goal steps, the completion of which may contribute to the user's progress toward completing the skill training objective. In some embodiments, one or more of the skill training objectives and/or the goal steps of the skill training objectives may be associated with one or more deadlines. In order to identify skill gaps, it may be beneficial to define the employee's present skill set (e.g., skills currently possessed by the employee, and optionally the corresponding skill levels) via baseline assessments, manager feedback, employee self-reporting, historical activity of the employee, or some combination of these.

It may sometimes be beneficial to define different skill training objectives may be defined for different skill levels of given skill. For example, an employee may possess no leadership skill, but may need an advanced leadership skill to meet their goal. In such circumstances, it may be beneficial to define multiple skill training objectives in leadership (e.g., basic leadership training, intermediary leadership training, and advanced leadership training) and/or to recommend these skill training objectives for the employee to acquire the advanced level of leadership skill needed to fill the skill gap.

As an example, the employee may be able to identify the role that they want within their organization, but may not be aware of the particular skills needed to succeed within the desired role, intermediate roles needed to be promoted to the desired role, or how such skills could be obtained (e.g., potentially including the order in which the skills should be obtained). Thus, in addition to the need for specific skills training for employees, there also exists a need to identify a skill path and/or a career path defining the skills and/or intermediate roles that the employee needs to obtain to achieve their goal and one or more sequences in which the skills and/or roles could or should be required, based on the employee's present skill set.

From a manager's perspective, such defined goals may include project-based goals. For example, a manager may desire to identify which employees should be assigned to a new project based on individual skill sets required for roles of the project. If the available employees do not possess the skill sets needed for the project, it may be desirable to identify corresponding skill gaps and to set skill training objectives for selected employees so that the skills required for the project may be obtained. It may further be desirable to monitor employee progress toward completing the skill training objectives (e.g., which may allow underperforming employees to be identified and corrective action to be taken).

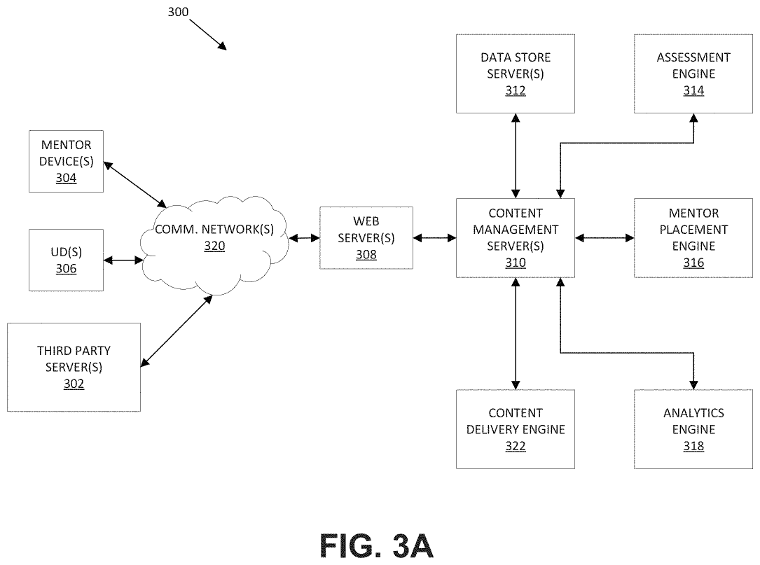

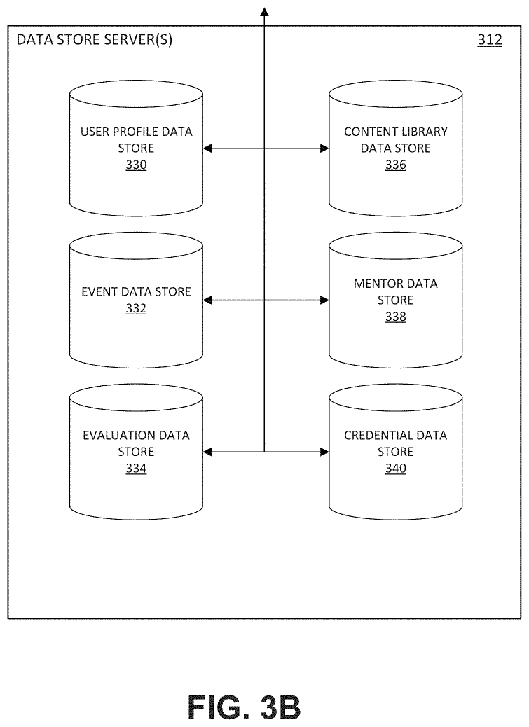

FIG. 3A shows an illustrative block diagram of a system 300 which may perform skill and goal analysis of a user (e.g., an employee), deliver assessments to the user (e.g., to evaluate whether an employee possesses one or more skills and, if so, the level of skill possessed by the employee), deliver training recommendations or goals (sometimes referred to herein as “skill training objectives”) to the user, validate that the user has acquired corresponding skills upon completion of training, and notify the user or a manager of the user once one or a defined group of skill training objectives have been completed. For example, the system 300 may be or may include an experiential digital learning system.

As shown, the system 300 may include one or more web servers 308, content management servers 310, data store servers 312, assessment engines 314, project placement engines 316, analytics engines 318, and content delivery engines 322.

Any or all of the assessment engine 314, the project placement engine 316, the analytics engine 318, and the content delivery engine may be implemented by executing computer-readable instructions with one or more processors of one or more servers of the system 300, which may include the content management servers 310, or other servers that are separate from the content management servers (not shown; e.g., servers 112, FIG. 1).

The web servers 308 (e.g., which correspond to at least a subset of the servers 102, 112 of FIG. 1) may be communicatively coupled to one or more user devices (UDs) 306, manager devices 304, and third party servers 302 via one or more communication networks 320 (e.g., network 120 of FIG. 1). For example, the web servers 308 may include hyper-text transfer protocol (HTTP)) servers, web application programming interface (API) servers, and the like. For example, the web servers 308 may handle incoming and outgoing network traffic, may pass incoming data to the resource management servers 310, and may pass outgoing data to the communication network 320 to be routed to a destination manager device 304, UD 306, or third party server 302.

For example, the web servers 308 may provide cross-domain and/or cross-platform web services in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the web servers 308 and user devices 306. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption.

The content management servers 310 (e.g., servers 102, FIG. 1; system 200, FIG. 2) may include any applicable type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 310 may include one or more server farms, clusters, or any other appropriate arrangement and/or combination of computer servers. Content management server 310 may act according to stored instructions located in a memory subsystem of the content management server 310, and may run an operating system, including any commercially available server operating system and/or any other operating systems discussed herein. The content management servers 310 may provide instructions to and receive information from the other devices within the system 300, in order to manage and transmit content resources, user data, and server or client applications executing within the system 300.

The data store server(s) 312 (e.g., servers 112 including data stores 110 of FIG. 1) may be communicatively coupled to the content management servers 310. Turning to FIG. 3B, a diagram is shown, illustrating different data stores 330-338 that may be included in the data store server(s) 312. As shown, the data store servers 312 may include a user profile data store 330, an event data store 332, an evaluation data store 334, a content library data store 336, and a project data store 338.

The paragraphs below describe examples of specific data stores that may be implemented within some embodiments of the system 300. It should be understood that the below descriptions of data stores 330-338, including their functionality and types of data stored therein, are illustrative and non-limiting. Data stores server architecture, design, and the execution of specific data stores 330-348 may depend on the context, size, and functional requirements of the system 300. For example, in professional training and educational applications, separate data stores, databases, or file-based storage systems may be implemented in data store server(s) 312 to store trainee and/or student data, trainer and/or professor data, training module data and content descriptions, training results, evaluation data, and the like. In applications involving media distribution from content providers to subscribers, separate data stores may be implemented in data stores server(s) 312 to store listings of available content titles and descriptions, content title usage statistics, subscriber profiles, account data, payment data, network usage statistics, etc.

The user profile data store 330 can include user metadata relating to a user's status, location, or the like. This information can identify, for example, a device a user is using, the location of that device, or the like. In some embodiments, this information can be generated based on any location detection technology including, for example, a navigation system, or the like. The user profile data store 330 can include user metadata identifying communication information associated with users identified in the user profile data store 330. This information can, for example, identify one or several devices used or controlled by the users, user telephone numbers, user email addresses, communication preferences, or the like.

Information relating to the user's status can identify, for example, logged-in status information that can indicate whether the user is presently logged-in to the system 300 and/or whether the log-in-is active. In some embodiments, the information relating to the user's status can identify whether the user is currently accessing content and/or participating in an activity from the content distribution network 330.

In some embodiments, information relating to the user's status can identify, for example, one or several attributes of the user's interaction with the system 300, and/or content distributed by the system 300. This can include data identifying the user's interactions with the system 300, the content consumed by the user through the system 300, or the like. In some embodiments, this can include data identifying the type of information accessed through the system 300 and/or the type of activity performed by the user via the system 300, the lapsed time since the last time the user accessed content and/or participated in an activity from the system 300, or the like. In some embodiments, this information can relate to a content program (e.g., course) comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since performing communication with a manager device 304 associated with a manager associated to the user or the content delivery engine 322, and/or the like.

In some embodiment, the user profile data store 330 can further include user metadata relating to the users' academic and/or educational history. This information can identify one or several courses of study that the user has initiated, completed, and/or partially completed, as well as grades received in those courses of study. In some embodiments, the student's academic and/or educational history can further include information identifying user performance on one or several tests, quizzes, and/or assignments.

The user profile data store 330 can include user metadata identifying one or several skills and, optionally, corresponding user skill levels possessed by users. In some embodiments, such user skill levels can identify a user's proficiency in a given skill based on the user's past performance in interacting with the system 300. In some embodiments, such user skill levels can identify a predicted skill level determined based on the user's past performance in interacting with the system 300 (e.g., by processing features characterizing the user's past performance or other applicable characteristics of the user with one or several predictive models, such as machine learning models). In some embodiments, skills possessed by the user may be determined based on the user's responses to one or more baseline assessments (e.g., designed to assess general skill proficiency or specific skill levels; which may be delivered via the assessment engine 314), as will be explained. In some embodiments, a third party (e.g., the user's supervisor or manager; via the manager device(s) 304) may endorse the user as possessing a general or specific level of proficiency in one or more skills. In some embodiments, skills associated with a user in the user profile data store 330 may be defined via self-report by the user, which may be helpful when identifying skills that are not easily quantifiable or observable.

In some embodiments, a user may take one or more training courses (e.g., via the system 300 or another system) specifically to develop one or more skills and, upon successful completion of such courses, the associated skills may be recorded in the user profile data store 330 as being possessed by the user. For example, “successful completion” of a course require the user to score a sufficiently high grade (e.g., exceeding a predefined threshold) on one or more summative assessments of the course, may require the user to score sufficiently high (e.g., exceeding one or more predefined thresholds) on individual or collective sections of a rubric associated with the course, and/or may require the user to receive positive feedback from a mentor or instructor through the duration of the course.

The user profile data store 330 can further include user metadata describing attributes of the user, such as the user's goals, field of work, learning style, and other applicable attributes. In some embodiments, the user's goals may include a desired role within the user's organization, or goals set by a manager of the user (e.g., via the manager device(s) 304).

The user profile data store 330 can further include one or more skill paths and/or career paths that have been generated for the user based on the user's goals. Here, a “skill path” refers to a progression of skills that can be obtained by a user via training to meet a goal (generally, to fill a skill gap). The skill path may be linear, with each skill training objective in the path recommended one at a time, or may include multiple parallel paths, where a user may select from a number of different skill training objectives when deciding which skill to undergo training for next. Similarly, a “career path” refers to a progression of jobs/roles that a user may need to obtain in order to qualify for a desired job/role. As with the skill path, the career path may be linear, offering one suggested role at a time, or may provide multiple parallel paths, each including roles that the user could obtain in order to progress to and qualify for their desired role.

As an example of how skill paths and career paths may be generated by the system 300, a user may upload (e.g., to the user profile data store 330 via a user device 306) a job posting corresponding to their desired role. The system 300 (e.g., the analytics engine 318) may analyze the uploaded job posting to determine a skill set required by the job posting, may compare the job's skill set to the user's skill set to identify a skill gap, and may create a skill path defining skill training objectives that the user can complete in order to fill the skill gap and qualify for the desired role. The system 300 may further identify one or more intermediate roles that may be required in the job posting, if relevant, and may create a career path that defines a progression of the one or more intermediate roles that ultimately lead to the desired role. In some cases, skill gaps may be identified for the intermediate roles, and corresponding skill training objectives may be added by the system 300 to the user's skill path. In some embodiments, the user may instead manually define skills required for the desired role and intermediate roles required to be obtained as prerequisites for obtaining the desired role, and the system may create the skill path and/or career path based on this manually input information. In some embodiments, a manager may define skill training objectives for a particular employee (e.g., in connection with a skill gap between that employee's skill set and a skill set needed for a given project), based on which the system 300 may create a skill path for the employee. In some cases, a user may instead set a goal of improving a skill level of an existing skill related to their current role or acquiring a skill related to their current role, and the system 300 may create a corresponding skill path and/or skill objectives.

The event data store 332 may include information identifying one or several interactions between a user of the user device 306 and other devices of the system 300. For example, the event data store 332 may include activity metadata characterizing interactions between a user and the system 300. For a given user, the activity metadata may include, but is not limited to: a characterization of randomness in the responses submitted by the user (e.g., in the form of a Hurst coefficient); one or more average “correct on first try” percentages for an assessment or aggregated from many assessments; an average score/grade which can include an average homework score and/or an average test score in a given course; an average item part score; a number of attempted item parts; an average number of attempted item parts; an average number of attempts per item part; and an aggregation parameter such as, for example, one or several course level aggregations. It should be understood that herein an “item part” refers to the smallest divisible part of a question to which a user may submit an answer. Some questions/items may include multiple parts, while others may only include a single part.

In some embodiments, these elements of activity metadata can be calculated with data collected within a window, which window can be a temporally bounded window, or a window bounded by a number of received responses. In such an embodiment, for example, the window can be a sliding window, also referred to herein as a sliding temporal window that can include information relating to some or all of one or several users' interaction with the system 300 during a designated time period such as, for example, a one week time period, a ten day time period, a two week time period, a three week time period, a four week time period, a six week time period, a twelve week time period, or any other or intermediate period of time.

The evaluation data store 334 may include information used to direct the evaluation of users and content resources in the system 300. In some embodiments, the evaluation data store 334 may contain, for example, the analysis criteria and the analysis guidelines for evaluating users (e.g., trainees/students, gaming users, media content consumers, etc.) and/or for evaluating content resources. The evaluation data store 334 also may include information relating to evaluation processing tasks, for example, the identification of users and user devices 306 that have received certain content resources or accessed certain applications, the status of evaluations or evaluation histories for content resources, users, or applications, and the like. Evaluation criteria may be stored in the evaluation data store 334 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

The content library data store 336 may include information describing the individual content items (or content resources or data packets) available via the system 300. In some embodiments, these data packets in the content library data store 336 can be linked to form an object network. In some embodiments, these data packets can be linked in the object network according to one or several sequential relationship which can be, in some embodiments, prerequisite relationships that can, for example, identify the relative hierarchy and/or difficulty of the data objects. In some embodiments, this hierarchy of data objects can be generated by the system 300 according to user experience with the object network, and in some embodiments, this hierarchy of data objects can be generated based on one or several existing and/or external hierarchies such as, for example, a syllabus, a table of contents, or the like. In some embodiments, for example, the object network can correspond to a syllabus such that content for the syllabus is embodied in the object network.

In some embodiments, the content library data store 336 can comprise a syllabus, a schedule, or the like. In some embodiments, the syllabus or schedule can identify one or several tasks and/or events relevant to the user. In some embodiments, for example, when the user is a member of a group such as a section or a class, these tasks and/or events relevant to the user can identify one or several assignments, quizzes, exams, or the like.

In some embodiments, the content library data store 336 may include metadata, properties, and other characteristics associated with content resources associated with one or more courses. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the content library data store 336 may be configured to allow updating of content metadata or properties, and to allow the addition and/or removal of information relating to the content resources. For example, content relationships may be implemented as graph structures, which may be stored in the library data store 336 or in an additional store for use by selection algorithms along with the other metadata.

In some embodiments, the content library data store 336 may include the content resources themselves, which may include question banks and/or definitions for delivery methods for quizzes, tests, and other assessments, training materials, presentations, plans, syllabi, reviews, evaluations, interactive programs and simulations, course models, course outlines, and various training interfaces that correspond to different materials and/or different types of user devices 306. For applications of the system 300 that involve media distribution, interactive gaming, and the like, the content library data store 336 may include media content files such as music, movies, television programming, games, and advertisements.

In some embodiments, the content library data store 336 can contain information used in evaluating responses received from users. In some embodiments, for example, a user can receive content from the system 300 (e.g., via the content delivery engine 332) and can, subsequent to receiving that content, provide a response to the received content. In some embodiments, for example, the received content can comprise one or several questions, prompts, or the like, and the response to the received content can comprise an answer to those one or several questions, prompts, or the like. In some embodiments, information, referred to herein as “comparative data,” from the content library data store 336 can be used to determine whether the responses are the correct and/or desired responses.

In some embodiments, the content library data store 336 and/or the user profile data store 330 can comprise an aggregation network, also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some embodiments, the content aggregation can comprise a grouping of content comprising the presentation portion that can be provided to the user in the form of, for example, a flash card and an extraction portion that can comprise the desired response to the presentation portion such as for example, an answer to a flash card. In some embodiments, one or several content aggregations can be generated by the system 300 and can be related to one or several data packets that can be, for example, organized in object network. In some embodiments, the one or several content aggregations can be each created from content stored in one or several of the data packets.

The project data store 338 may include a listing of projects and corresponding project profiles. For each project, a corresponding project profile may defined a number of roles, each requiring a defined skill set to be possessed by the employee that fills or is to fill that role. In some embodiments, a manager may manually define (e.g., via inputs provided at the manager device(s) 304) a project and its roles. In some embodiments, the manager may upload (e.g., to the project data store 338 via the manager device(s) 304) a project description, and the system 300 (e.g., the analytics engine 318) may automatically populate the roles for the project and/or the skill sets for each role based on the project description.

For a given project, the project data store 338 may define each employee that is presently assigned to the project and which of the project's roles those employees fill. The project data store 338 may further identify any unfilled roles (i.e., to which an employee has not yet been assigned) for the project, and may identify employees that are applicable candidates for such unfilled roles. For example, the project placement engine 316 may determine which employees are applicable candidates for unfilled project roles. If no applicable candidates exist for an unfilled role, the project data store 338 may further include an ordered list of available employees having skill sets that most closely match the skill set required by the unfilled role, and may identify a skill gap for each employee included on the ordered list. For example, the ordered list may be populated by the project placement engine 316, which may also determine the skill gaps for the employees on the list.

Returning to FIG. 3A, the assessment engine 314 may deliver assessments (e.g., quizzes, exams, homework assignments, etc.) to the user devices 306, and may process responses submitted to assessment questions via the user devices 306. Such assessments may be used to determine whether a user is proficient in a given skill, in some embodiments. For example, when delivering a given assessment, the assessment engine 314 may first retrieve questions from an associated question bank (e.g., from the content library data store 336 of the data store servers 312). The assessment engine 314 may then cause (e.g., via communication via the content management servers 310, web servers 308, and/or communication networks 320) the questions to be displayed at the user device 306 at which the assessment is being delivered, either in a predefined order, or in a random order, depending on defined attributes of the assessment being delivered. The assessment engine 314 may receive (e.g., via communication via the content management servers 310, web servers 308, and/or communication networks 320) responses submitted at the UD 306. The assessment engine 314 may cause these responses to be stored at a location (e.g., within a data store) within a memory device (e.g., evaluation data store 334 or event data store 332 of the data store servers 312), the location being associated with the particular assessment delivery event. The assessment engine 314 may determine and store a score (e.g., corresponding to the response being correct, incorrect, partially correct, etc.) for each response. For example, the assessment engine 314 may determine the score via reference to an associated, predetermined correct response stored in memory, such as in the content library data store 336. In some embodiments, response scores may be determined manually by an instructor or evaluator (e.g., according to a rubric), and may then be uploaded to the assessment engine 314 for entry into memory. In some embodiments, when the assessment ends, unanswered questions of an assessment may be automatically assigned a score of zero. Upon completion of the assessment (e.g., in response to the assessment being submitted by a user via interaction with the user device 306, or in response to a time limit associated with the assessment delivery event having elapsed), the assessment engine 314 may generate one or more grades for the assessment based on the scores determined for each response.

The assessment engine 314 may deliver one or more baseline assessments to determine the respective skill level of a user with respect to one or more skills. For baseline assessments, the “grade” determined by the assessment engine 314 may be translated into an estimated skill level of the user for a given skill. In addition to identifying a user's skill proficiency/skill level, these baseline assessments may also identify whether a user possesses a given skill or set of skills at all. For example, if a job for which a user wishes to apply requires a set of skills A, B, and C, the user may be evaluated by the system 300 to determine whether they are proficient in each of skills A, B, and C. For example, as an initial step, the assessment engine 314 may deliver baseline assessments to verify the user's proficiency in skill A, in skill B, and in skill C. In some embodiments, respectively separate baseline assessments may be delivered for each skill being evaluated, while in other embodiments, if applicable, two or more skills may be evaluated via a single baseline assessment. As discussed previously, a skill path may be established for the user (e.g., by the analytics engine 318) identifying skills that the user should acquire or develop in order to better qualify for their goal job/role, and/or one or more sequences in which the user could acquire such skills.

The assessment engine 314 may deliver one or more formative assessments to a user as the user progresses through a course in which the user is enrolled. The formative assessments may evaluate the user's understanding of newly introduced concepts as they are being taught, for example.

The assessment engine 314 may deliver one or more summative assessments to a user as the user reaches one or more progress thresholds via their progression through a course in which the user is enrolled. The summative assessments may evaluate how well the user has learned concepts taught by the course as a whole, or within a particular section of the course. In some embodiments, the results of the summative assessment(s) within a course may be the basis for determining whether the user will receive a credential for their participation in the course.

In some embodiments, the assessment engine 314 may deliver one or more post-course assessments to a user to verify that the user has retained information learned during a course in which they were previously enrolled. For example, an employer may have an employee take a course to develop a particular skill, and may wish to verify that the employee has retained the skill following the course. A high grade on such post-course assessments may therefore confirm to the employer that the user has successfully retained the skill or skills learned during the course. Conversely, a low grade on such post-course assessments may indicate to the employer that the user may need to be re-trained in the skill or skills due to lack of retention.

The project placement engine 316 may analyze a project in the project data store 338 along with available employees/users represented in the user profile data store 330 in order to identify employees that are applicable candidates for each unfilled role of the project. For example, the project placement engine 316 may perform a statistical analysis or apply an artificial intelligence model, such as a machine learning model, to user information (e.g., a user's skill set) of multiple available employees (which may be retrieved from the user profile data store 330) and to requirements (e.g., a required skill set) that have been defined for the unfilled role. The project placement engine may then identify any employees having skill sets that are a valid match for the skill set required by the unfilled role as being applicable candidates. Here, an exact one-to-one match may not be required to be a valid match, but rather the employee skill set may encompass (i.e., include all the skills and skill levels of) the required skill set.

In some embodiments, upon identifying an applicable candidate for an unfilled role of the project, the project placement engine 316 may automatically assign the applicable candidate to the role. In other embodiments, the project placement engine 316 may instead send (e.g., via the web servers 308 and/or the communication networks 320) a recommendation to a manager device 304 based on its analysis, the recommendation identifying the unfilled role and one or more of the identified applicable candidates. A corresponding manager may then select a user from among the applicable candidates to fill the role, which may be recorded in the project data store 338.

For situations in which no applicable candidates exist, the project placement engine may instead identify one or several employees who have skill sets that are a “close match” to the required skill set of the unfilled role. Here, a “close match” can be distinguished from the “valid match” described above in that an employee skill set that is a close match does not encompass each and every one of the skills or skill levels of the required match—at least one skill or skill level defined in a corresponding required skill set would be lacked by a closely matching employee skill set. For example, a close match may be identified based on the existence of a skill gap between an employee skill set and the skill set of the unfilled role including less than a predetermined threshold number of skills and/or skill levels. For example, in such an embodiment, an employee's skill set may be identified as a close match for the skill set of the unfilled role if the project placement engine 316 determines that a skill gap between the employee's skill set and the skill set of the unfilled role includes fewer than 5 skills. In some embodiments, different skills and skill levels within a given skill gap may be assigned different weights (e.g., to convey relative differences in importance between certain skills and skill levels), such that lacking a highly weighted skill may have a larger impact on an employee's ability to be considered a “close match” for a role, compared to that of a lower weighted skill.

In some embodiments, upon identifying a list of candidates that are a “close match” for an unfilled role, the project placement engine 316 may automatically, or in response to instructions received from a manager via the manager devices 304, generate skill training objectives for one or more of the candidates of the list. The skill training objectives for a given candidate may be sent to (e.g., by the project placement engine 316 and/or content management servers 310) and displayed at user devices 306 associated with candidate and/or the manager devices 304. For clarity, skill training objectives generated for a particular project may be referred to herein as “project-based skill training objectives” to better differentiate them from skill training objectives that may be generated for an employee to meet their personal goals.

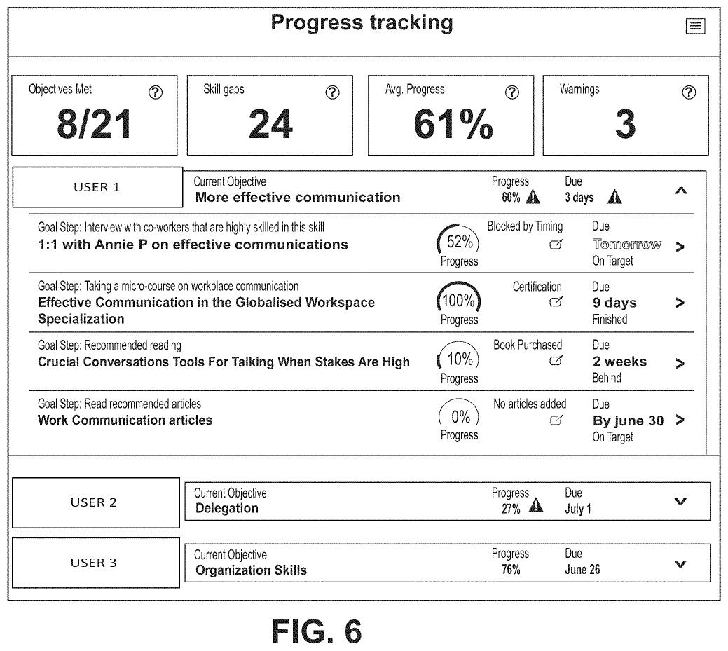

In some embodiments, project-based skill training objectives for multiple employees (e.g., all employees associated with an organization, associated with a particular manager, or associated with a particular project) may be aggregated and displayed at one or more of the manager devices 304, for example, as part of a user interface (UI). An example of such a user interface is shown in FIG. 6. As shown, the manager's UI may include a skill objectives metric showing the number of skill objectives met by employees (e.g., associated with associated with the manager or associated with one or more projects associated with the manager) out of the total number of skill objectives that have been assigned to the employees. In some embodiments, these skill objectives may be limited to a particular project, while in others they may encompass employee skill objectives for multiple projects. The manager's UI may further include a skill gaps metric showing a number of skill gaps (here representing a number of individual skills or skill levels of individual skills that need to be acquired by the manager's employees for the project or project associated with the UI). The manager's UI may further include an average progress metric indicating the average progress of the employees toward completing their skill training objectives. The manager's UI may further include a warnings metric, which may represent a number of warnings that have been issued for the employees represented in the UI. For example, a warning may be issued for an employee if the employee's progress is below one or more predetermined thresholds, the value of which may vary depending on the number of days remaining until individual goal steps of a skill training objective are due to be completed.

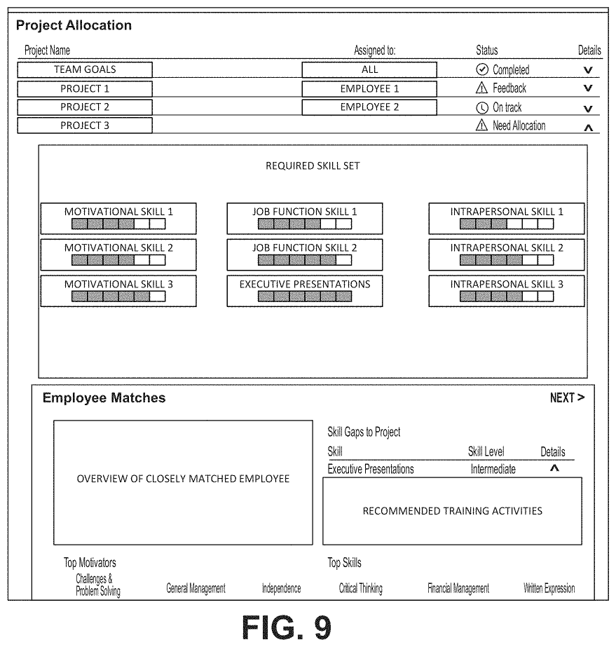

In some embodiments, the system 300 may generate and display a UI for project management (i.e., project management UI) at the manager device 304. FIG. 9 illustrates an example of such a project management UI. As shown, the project management UI of FIG. 9 includes a listing of projects associated with a manager, with each entry in the listing defining a project name, one or more employees assigned to the project, and a project status indicator. For project 3 of the present example, an employee has not yet been assigned. The entry for project 3 has been expanded to display the required skill set for an unfilled role of the project, and to display a closely matched employee (e.g., as identified by the system 300, project placement engine 316, and/or analytics engine 318). The employee match window may include an overview of identifying information for the closely matched employee, a listing of top motivators for the employee (e.g., based on motivational assessments, employee self-report, and/or manager report), a listing of top skills for the employee (e.g., identified via skill assessments, employee self-report, manager report, and/or historical activity), a listing of identified skill gaps for the employee for project 3, and a list of recommended training activities corresponding to one or more of the identified skill gaps. The manager may review multiple closely matched employees via the employee match window when selecting which employee to assign to project 3.

Returning to FIG. 3A, the analytics engine 318 may retrieve user information for a given user from the user profile data store 330, and may analyze this data to generate a skill path for the user. For example, the analytics engine 318 may identify the user's goal (e.g., a desired job or role being offered by an employer) from the user metadata, may identify a “skill gap” between the user's skills and/or skill levels and the skills and/or skill levels required to achieve the user's goal (e.g., prerequisite skills needed to qualify the user for the desired job or role). As another example, the analytics engine 318 may identify skill gaps between user skill sets and the required skill set for an unfilled role, as described above.

For example, the analytics engine 318 may determine via analysis of a job posting associated with the user's goal that the corresponding job requires proficiency in planning, communication, decision making, delegation, problem solving, and motivating subordinates. The analytics engine 318 may analyze the user metadata of the user, and may identify that the user already possesses demonstrated experience (e.g., based on results of skill assessments taken by the user, manager-reported skill experience, user self-reported skill experience, or experience identified via analysis of historical activity of the user with the system 300) in planning, communication, and decision making, and has undergone training in delegation, but does not possess any experience, training, or credentials for problem solving and motivating subsidiaries. Based on this identified skill gap, the analytics engine 318 may determine that the user could meet the requirements for the desired job if they received training in problem solving and motivating subordinates. The analytics engine 318 may then generate and send a recommendation to the user device 306 of the user, the recommendation including two skill training objectives, one to obtain experience and/or training in problem solving, and the other to obtain experience and/or training in motivating subordinates.

In some embodiments, the analytics engine 318 may analyze assessment results (e.g., retrieved from the evaluation data store 334) for an assessment taken by a user, the assessment providing evaluation of whether the user possesses a skill, and the user's corresponding skill level. The analytics engine 318 may determine the skill level (e.g., proficiency level) of the user in the skill via this analysis. The analytics engine 318 may cause the determined skill level to be stored in the user profile data store 330 in connection with the user.

The content delivery engine 322 may deliver content resources for a training course (e.g., formative and summative assessments, activities, presentations, guided discussion, scenarios, videos, games, syllabi, objectives, reflections, and/or the like) to a user device 306 of a user enrolled in that training course. Such resources may be delivered by the content delivery engine 332 via the content management servers 310, web servers 308, and communication networks 320. The content delivery engine 322 may deliver content resources according to a given user's progress through a course in which they are enrolled, which may be monitored by the content management servers 310 and/or the analytics engine 318. In some embodiments, a user's progress through a given training course may be reported by the content management servers 310 to one or more of the manager devices 304 (e.g., of one or more managers associated with that user).

While the system 300 may provide training courses to a user when assisting the user in completing skill training objectives, in some embodiments a user may choose to undergo training using third party training courses. For example, a user may use a user device 306 to enroll in and progress through a training course via electronic communication with the third party servers 302 via the communication networks 320. In such embodiments, user progress may be reported by the third party servers 302 to the manager devices 304, user devices 306, and/or data store servers 312 (e.g., and stored in the user profile data store 330).

Any of the third party servers 302, the manager devices 304, the UDs 306, the front-end servers 308, the content management servers 310, the data store servers 312, the assessment engines 314, the project placement engines 316, the analytics engines 318, and the content delivery engines 322 may be or may be implemented by computer systems similar to the system 200 of FIG. 2.

FIG. 4A shows an illustrative process flow of a method 400 by which skill training objectives can be established for a user based on the user's goals and possessed skills, and the user's completion of the skill training objectives can be monitored. The method 400 may be, for example, performed via the execution of computer-readable instructions via one or more computer processors (e.g., processors 204 of FIG. 2), which may be included in one or more computer servers (e.g., servers 102, 112, 308, 310, 312, FIGS. 1, 3; device 200, FIG. 2) in communication with one or more data stores (e.g., data stores 110, 330, 332, 334, 336, 338, FIG. 3B). The steps of the method 400 are described as being performed using one such processor, though it should be understood that multiple processors may be used. Examples of how the steps of the method 400 can be applied are provided in the context of FIGS. 3A and 3B and corresponding reference numerals are therefore used. In some embodiments, the computer-readable instructions may define one or more sequences in which content, courseware, data, assessments, and/or other interactives are presented to users in connection with the method 400.

At step 402, a processor creates a user profile for a user. For example, the processor may collect information about the user (e.g., results of motivational assessments taken by the user, results of interest assessments taken by the user, user-reported information from a user device 306, manager-reported information from a manager device 304, historical activity of the user with the system 300, results of skill assessments taken by the user, or other relevant information). The processor may upload or otherwise cause the collected information to be stored at the user profile data store 330 as it is collected.

An example of steps 422-434 that the processor may perform in creating the user profile for the user is shown in FIG. 4B. In some embodiments, the steps 422-434 may be performed in any order. It should be understood that the performance of one or more of the steps 422-434 may be optional.

At step 422, the processor may cause one or more motivational assessments to be delivered to the user. In order to identify roles within an organization for which the user may be suited, it may be sometimes useful to identify motivations of the user. Additionally, these motivational assessments may be used by the system 300 as a basis for identifying areas for improvement or development within the user's current role.

For example, the user may be prompted to initiate a motivational assessment at a user device 306. In response, the assessment engine 314 may retrieve content (e.g., questions, an order in which the questions should be presented) of a motivational assessment from content library data store, and may cause the user device 306 to present the content to the user to deliver the motivational assessment. The user's responses (i.e., motivational assessment responses) to questions of the motivational assessment may be collected and stored in the event data store 332. The analytics engine 318 may compare the user's motivational assessment responses to corresponding analysis criteria stored in the evaluation data store 334 in order to determine one or more motivations (i.e., user motivations) of the user. These user motivations may be stored in the user profile data store 330 as part of the user profile of the user. For example, these user motivations may identify whether the user is motivated by money, recognition, meaningful work, accountability, appreciation, job security, interesting work, loyalty from management, career advancement opportunities, or other applicable motivating factors.

At step 424, the processor may cause one or more interest assessments to be delivered to the user. In order to identify roles within an organization for which the user may be suited, it may be sometimes useful to identify particular interests of the user. Additionally, these interest assessments may be used by the system 300 as a basis for identifying areas for improvement or development within the user's current role.

For example, the user may be prompted to initiate an interest assessment at a user device 306. In response, the assessment engine 314 may retrieve content (e.g., questions, an order in which the questions should be presented) of an interest assessment from content library data store, and may cause the user device 306 to present the content to the user to deliver the interest assessment. The user's responses (i.e., interest assessment responses) to questions of the interest assessment may be collected and stored in the event data store 332. The analytics engine 318 may compare the user's interest assessment responses to corresponding analysis criteria stored in the evaluation data store 334 in order to determine one or more interests (i.e., user interests) of the user. These user interests may be stored in the user profile data store 330 as part of the user profile of the user. For example, these user interests may include interests in taking on greater leadership roles, taking on more challenging work, performing particular types of work, mentoring others, utilizing particular skills, or other applicable interests.

At step 426, the processor may receive self-reported goals of the user from the user device 306, and may store the self-reported goals in the user's profile in the user profile data store 330. For example, if the user wishes to obtain a particular role within their organization, the user may specify acquiring that role as one of their self-reported goals. As another example, the user may set a goal of improving the skill level of one or more skills that they utilize in their current role, or acquiring skills related to their current role.

At step 427, the processor may receive manager-reported goals from a manager associated with the user (e.g., who is a supervisor of the user) via a corresponding manager device 304. The processor may store the self-reported goals in the user's profile in the user profile data store 330. For example, the manager may set one or more goals (e.g., and corresponding skill objectives) for the user based on skill gaps between the user's skill set and the required skill set of a role of a project to which the manager desires to assign the user.

At step 428, the processor may receive self-reported skills of the user from the user device 306, and may store the self-reported skills in the user's profile in the user profile data store 330. It may not be simple or possible to ascertain whether a user possesses certain skills, such as leadership, reliability, or time management, for example, through assessment. Instead, such skills (sometimes referred to as “soft skills”) may be identified via self-report by the user, or by report of one or more managers of the user (i.e., manager-reported skills).

At step 430, the processor may receive manager-reported skills of the user from a manager device 306 (e.g., corresponding to a manager associated with the user, where such association may be defined in the user profile data store 330), and may store the manager-reported skills in the user's profile in the user profile data store 330.

At step 432, the processor may cause one or more skill assessments to be delivered to the user. While it may be difficult to verify a user's possession of some skills via assessment, this may be a valid approach for evaluating other skills such as technical proficiencies, language proficiencies, typing speed, machine operation, computer programming, problem solving, and the like. For example, the user may be prompted to initiate a skill assessment at a user device 306. In response, the assessment engine 314 may retrieve content (e.g., questions, an order in which the questions should be presented) of a skill assessment from content library data store, and may cause the user device 306 to present the content to the user to deliver the skill assessment. The user's responses (i.e., skill assessment responses) to questions of the skill assessment may be collected and stored in the event data store 332. The analytics engine 318 may compare the user's skill assessment responses to corresponding analysis criteria stored in the evaluation data store 334 in order to determine one or more skills possessed by the user and/or one or more skill levels thereof. A record of these user skills and/or skill levels may be stored in the user profile data store 330 as part of the user profile of the user.

At step 434, the processor may analyze historical data associated with the user to identify skills (sometimes referred to as historical skills) that the user has obtained via previous interactions with the system 300 (e.g., via completion of courses delivered to the user via the system 300). For example, if the user has previously completed training in a programming course via interaction with at least the content delivery engine 322, the processor may determine that the user possesses a corresponding programming ability as a historical skill.

Returning to FIG. 4A, at step 404, the processor determines user goals based on the user's profile. For example, the processor may retrieve the user's profile from the user profile database 330, then may identify user goals based on the self-reported goals of the user from the user's profile.

At step 406, the processor determines required skills for each of the user goals. For example, a given user goal may be to acquire a particular job. The user goal may include a definition of the job, and may include a listing of explicit required skills. In some embodiments, the user goal may additionally or alternatively include a job description, and the processor may analyze the job description to identify implicit required skills.

At step 408, the processor determines user skills based on the user's profile. For example, the processor may analyze the user profile to identify any self-reported skills, manager-reported skills, historical skills, and skills determined via assessment of the user, and/or corresponding skill levels. The processor may define a skill set for the user that includes any or all such identified skills.

At step 410, the processor identifies one or more skill gaps that exist between the user's skill set and the respective required skill set for each of the user's goals. For a give user goal, the processor may compare the required skill set for that user goal to the user's skill set, and identify a skill gap that includes differences in skills and/or skill level between the required skill set and the user's skill set.

At step 412, the processor generates skill training objectives for each skill and/or skill level included in the identified skill gaps. For example, if a skill gap includes a leadership skill, the processor may generate a skill training objective for leadership. The skill training objective may be stored in the user profile of the user in the user profile data store 330. The skill training objective may serve as a recommendation that the user receive training in a corresponding skill. A skill training objective may be considered completed when the user has received training in the corresponding skill. The collective skill training objectives for a given user goal may be considered a “skill path” for the user for that goal.

At step 414, the processor causes the skill training objectives generated at step 412 to be displayed at the user device 306. In some embodiments, the processor may generate skill training recommendations (e.g., corresponding to skill training courses that are available for delivery by the content delivery engine 322), which may then be displayed at the user device 306 as part of a user interface (UI).

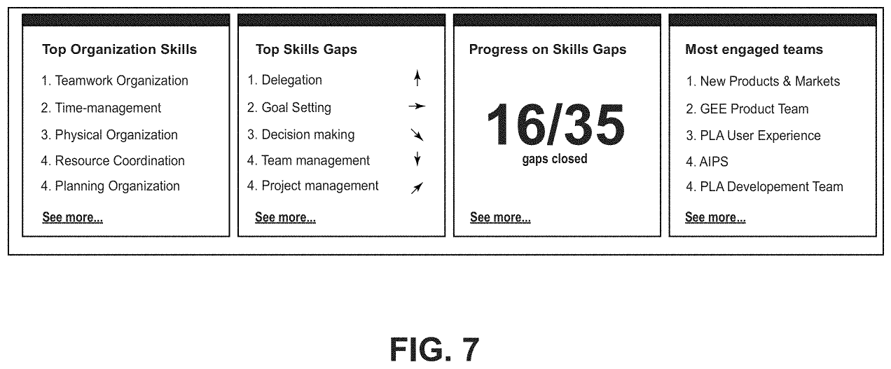

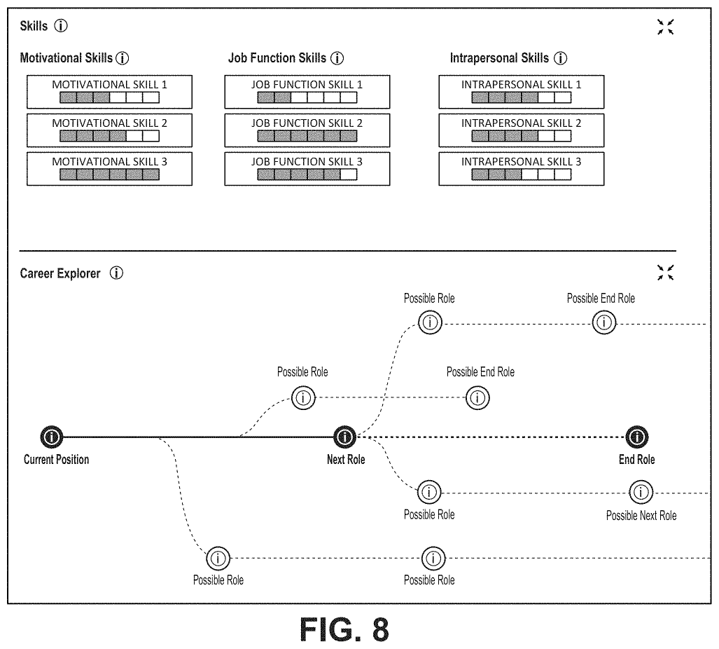

Illustrative screens that may be displayed to a given user as part of such a UI are shown in FIGS. 7 and 8. FIG. 7 shows a screen of a user interface that includes metrics and ranked lists for an individual user, related to the user's skills and skill gaps. As shown, the UI may include a list of the user's top organizational skills (e.g., ordered based on respective skill levels). It should be understood that this is an illustrative example, and that other skill categories may be displayed in the UI other than top organizational skills. The UI may additionally include a list of the user's top skill gaps (e.g., ordered based on skill level differential between the user's skill level and the required skill level for each respective skill gap). The UI may additionally include a progress metric showing a fraction of the number of skill gaps closed by the user (e.g., via completion of skill training objectives) to the total number of skill gaps that have been identified for the user. The UI may additionally include a list of teams with which the user is actively engaged.

FIG. 8 shows a screen of a user interface that includes the skills of the user's skill set (e.g., as determined by the system 300 based on the self-reported skills, manager-reported skills, skills determined via assessment, and historical skills represented in the user profile of the user) and their respective skill levels, as well as a career path for the user (e.g., as determined by the system 300 based on the user's goal or goals and/or motivation and interest assessment results). As shown, the overall skill set of the user may be organized into multiple categories, including motivational skills, job function skills, and intrapersonal skills in the present example. The career path may include the user's current position, an end role that the user desires to acquire, and an intermediate or “next” role that the user must acquire before qualifying for the desired end role. The career path may further include optional alternative career paths, which may include alternative end roles, and alternative intermediate roles for those alternative end roles.

Returning to FIG. 4A, at step 416, the processor monitors skill training performed by the user. For example, if the skill training is performed via the system 300, the content delivery engine 322 may track (e.g., via, at least in part, updates to the user profile data store 330) the user's progress through various skill training courses, and when a given skill training course is complete, may record that a corresponding skill training objective has been completed. In some embodiments, the successful completion of a skill training course may be contingent on the user passing (e.g., scoring higher than a threshold score on) one or more assessments delivered at the end of the course or at checkpoints during the course. If the user undergoes skill training via a third party service, corresponding third party servers 302 may report user progress or user completion of skill training courses to the system 300, or the user may provide confirmation from the third party service of completion of the skill training course. The processor may additionally update the skill gaps recorded in the user profile of the user as the user acquires skills via training and completes skill training objectives.

At step 418, the processor determines whether all skill training objectives defined for the user are completed. In some embodiments, this may be limited to skill training objectives for an individual user goal, while in other embodiments, this may encompass all skill training objectives for all user goals. If all skill training objectives have been completed, the method 400 proceeds to step 420. Otherwise, the method 400 returns to step 414.

At step 420, the processor sends an alert to the user device 306 associated with the user and/or a manager device 304 of a manager associated with the user. The alert may be sent via the communication networks 320 and/or the web servers 308, for example. In some embodiments, the alert may be displayed via the manager UI, text message, e-mail, push notification, or other forms of electronic alert. The method 400 may then end.

FIG. 5 shows an illustrative process flow of a method 500 by which employees (e.g., users) may be assigned to roles of a project based on their skill sets, skill gaps for one or more roles may be identified, and employee progress towards completing skill objectives to fill the skill gaps may be monitored. The method 500 may be, for example, performed via the execution of computer-readable instructions via one or more computer processors (e.g., processors 204 of FIG. 2), which may be included in one or more computer servers (e.g., servers 102, 112, 308, 310, 312, FIGS. 1, 3; device 200, FIG. 2) in communication with one or more data stores (e.g., data stores 110, 330, 332, 334, 336, 338, FIG. 3B). The steps of the method 500 are described as being performed using one such processor, though it should be understood that multiple processors may be used. Examples of how the steps of the method 400 can be applied are provided in the context of FIGS. 3A and 3B and corresponding reference numerals are therefore used. In some embodiments, the computer-readable instructions may define one or more sequences in which content, courseware, data, assessments, and/or other interactives are presented to users in connection with the method 500.

At step 502, a processor receives a project profile. The project profile may define, for example, a number of roles required for the project. At step 504, the processor determines required skill sets for each role of the project (e.g., via analysis of the project profile). For each role, a respective required skill set is defined in the project profile. For an employee to be eligible fill a given role, that employee would need to possess a skill set that includes all of the skills and, in some cases, skill levels as those included in the required skill set for that role. In some embodiments, the project profile may include a description of the project or of individual roles for the project, and implicit required skills for a given role may be identified by the processor via analysis of such aspects of the project profile. The processor may include such implicit required skills in the required skill set for the project.

At step 506, the processor identifies a set of available users having user skill sets that closely match respective required skill sets for the roles of the project. For example, the processor, via the project placement engine 316 may first analyze the user profile data store 330 to identify available employees (e.g., employees who are available to work on the project). The project placement engine 316 may then identify available employees having skill sets that match required skill sets of roles of the project (e.g., employee skill sets that include all of the skills and/or skill levels required for those roles). The project placement engine 316 may then automatically assign the employees to the roles (e.g., which may be recorded in the project data store 338) to which they are matched, or may send recommendations for the assignment of these employees to these roles to one or more manager devices 304. If all roles of the project are filled in this way, the method may end. However, in some cases, upon this initial matching some roles of the project may remain unfilled. If unfilled roles remain, the project placement engine 316 may identify a set of available employees (i.e., “closely matched users” or “closely matched employees”) having skill sets that most closely match (e.g., respective to skill sets of other available employees) the required skill sets for each unfilled role of the project, as described above.

At step 508, for each closely matched employee, the processor identifies skill gaps between that employee's skill set and the required skill set of the role to which the employee has been matched. For example, the analytics engine 318 may, for each employee, compare the skills and/or skill levels of that employee's skill set to those of the required skill set of the role to which that employee has been matched. Required skills and/or skill levels not possessed by a given employee are identified as skill gaps for that employee based on this comparison.

At step 510, the processor generates skill training objectives for each of the closely matched employees. For example, for a given closely matched employee, skill training objectives may be assigned to that employee by the analytics engine 318 for each skill gap identified for that employee at step 508. In some embodiments, a single skill training objective may correspond to closing skill gaps for multiple skills and/or multiple skill levels. For example, a skill training objective may correspond to training for the acquisition of multiple skill levels for an individual skill. For example, a skill training objective may correspond to training for the acquisition of multiple skills.

At step 512, the processor causes metrics related to the closely matched employees to be displayed at one or more manager devices 304, correspond to one or more managers associated with the project. For example, the content management servers 310 may cause a manger UI (e.g., which may include the screen shown in FIG. 6) to be displayed at the manager devices 304. The manager UI may include metrics representing each of the closely matched employees. These metrics may include a skill objectives metric, a skill gaps metric, an average progress metric, a warnings metric, or other aggregate metrics (e.g., as described in connection with FIG. 6) that represent aspects of closely matched employees' progress toward completing assigned skill objectives and closing skill gaps.

At step 514, the processor monitors employee progress through skill training (e.g., via electronic communication with corresponding user devices 306 at which the skill training is being performed and/or with third party servers 302) and updates the metrics displayed in the UI at the manager devices 304 accordingly (e.g., by sending updated data to the manager devices 304 via the content management server 310, web server 308, and communication networks 320).

At step 516, the processor determines whether all skill training objectives for the project have been successfully completed. For example, the processor may analyze the skills objectives metric to determine whether all skill training objectives associated with the project have been successfully completed. In some embodiments, the processor may instead make this determination based on the skill gaps metric. If all skill training objectives for the project have been successfully completed, the method proceeds to step 518. Otherwise the method returns to step 512, such that steps 512-516 may repeat iteratively until all skill training objectives for the project have been completed.

At step 518, the processor may send an alert to the manager device or devices 304 associated with the project. The alert may indicate that the skill training objectives for the project have been completed and/or that the skill gaps for the project have been successfully closed. For example, the alert may be generated and sent by the content management servers 310 via the web servers 308 and communication networks 320. In some embodiments, the alert may be displayed via the manager UI, text message, e-mail, push notification, or other forms of electronic alert. In some embodiments, the user devices 306 associated with closely matched users may also be alerted in this way. The method 500 may then end.

In some embodiments, the disclosed system may apply the embodiments disclosed above within an academic environment, using a skill based recommendation engine to help lifelong learners identify potential skill gaps, as well as solutions to address those skills gaps, specifically academic programs. In such academic environments, research indicates that lifelong learners are in the market for higher education, but don't know what degree they want, or the academic organization (i.e., brand) from which they want to receive it. However, currently, no marketplaces exist for learners to better define the degree and academic program that they want. Instead, current models used by academic institutions to determine an academic path require a user to identify and select a program or brand that the user is familiar via search engine results, fill out a lead form, and wait for contact from the institution, resulting in a discovery session, where the user and an enrollment advisor discuss the user's options. The user is often left on their own in a fragmented experience, moving back and forth between online and phone-based interactions, which may be overwhelming to the user when trying to make selections. As a result, the user may spend considerable amounts of money, and not have a program that is a good fit for the user. Thus, what is needed is a business model, possibly including an academic institution marketplace, which directs users to their most effective academic program.

The goal of the disclosed embodiments is to utilize the disclosed recommendation engine that receives responses for multiple survey questions from a user to identify optimal solutions for enrollment that targets a learner user's specific goals, and identifies multiple learning pathways and solutions for a user. In some embodiments the disclosed recommendation engine may be fine tuned enough to discern the difference between the programs the learner is seeking. As non-limiting examples, for a user seeking further education in analytics, the disclosed recommendation engine may be configured to distinguish between a certificate, a master's degree, an MBA with a concentration in analytics, or taking a short course on analytics

As a preliminary step, system administrators may populate data store 110 with available products, including available academic programs and the respective details about those programs. The system administrators may then input data regarding one or more skills associated with each of the available products/academic programs. Similarly, the system administrators, or other subject matter experts (SMEs) may populate the database with one or more skills associated with each of the input academic programs. In some embodiments, SMEs may work with one or more academic strategy teams, possibly associated with the provider of the disclosed system to evaluate available learning products. In some embodiments, these SMEs may research the programs available through university or other third party partners to determine which career outcomes are most likely for program degrees, based upon data from the academic programs regarding graduations from those institutions. Using the data within the database described above, the disclosed system, possibly using user input, may generate a map between the available programs, the available products, and the skills associated with both.

Although some embodiments may have very generic descriptions and relationships between certain careers/roles and the skills associated with those roles based on known standards, in some embodiments, the mapping within the disclosed system between the user's current career/role and the skills may include an enhanced separation of skills, which may be increasingly detailed, so that each of the skills has an increasingly granular number of levels of skills within the skills taxonomy. As a non-limiting example, a first user may be familiar with Microsoft Excel at a general level, but a financial analyst may have a much more detailed knowledge of Microsoft Excel. The first user may therefore have a general knowledge of Excel, so may be associated in the skills taxonomy with a level 1 skill level for Excel. The financial analyst may be associated in the skills taxonomy with a level 3 for Excel, and so forth.

Using the data stored in the database associated with the skills in the database and the roles or careers stored in the database, the disclosed embodiments may generate a taxonomy or other model representing the mapping between specific skills stored in the database, and the roles/careers stored in the database. This taxonomy may define which skills in the database are associated with specific roles or careers stored in the database. This taxonomy may specifically map one or more careers in the database to one or more skills stored in the database to create a “skills map.” The system may then map, and create relationships between, the skills, the career choice, and the user's current career/role. In some embodiments, the system may generate tags associating the skills and the learning products, and the skills to the career choices, current career, and potential career outcomes. As providing a pathway depends on the data of the institution, system administrators and/or subject matter experts (SMEs) may then populate the database with available academic programs and their associated skills. This data may include one or more consideration sets including data to do the mapping between the available academic programs and their associated skills.

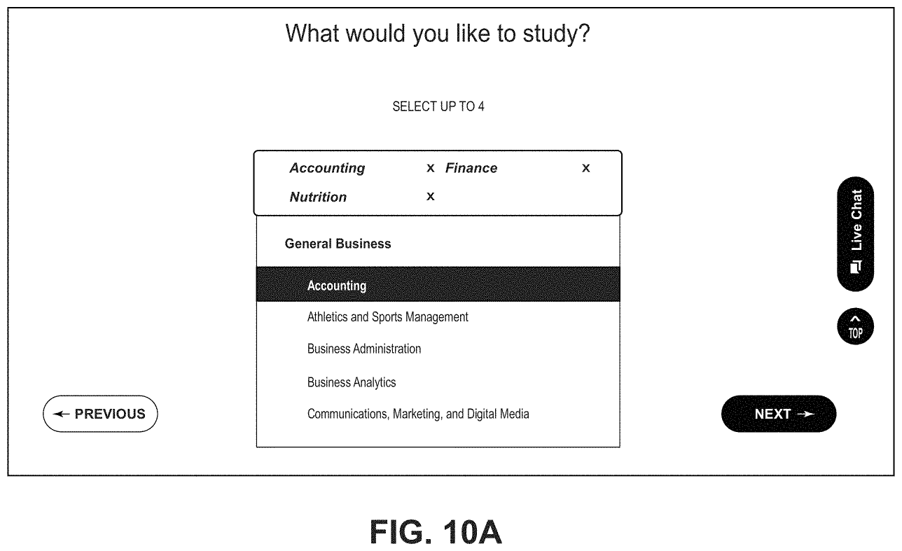

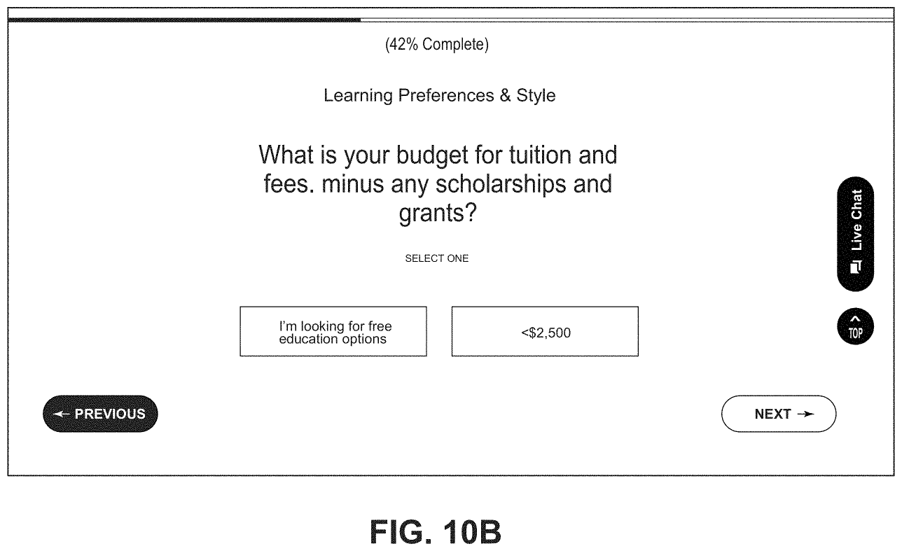

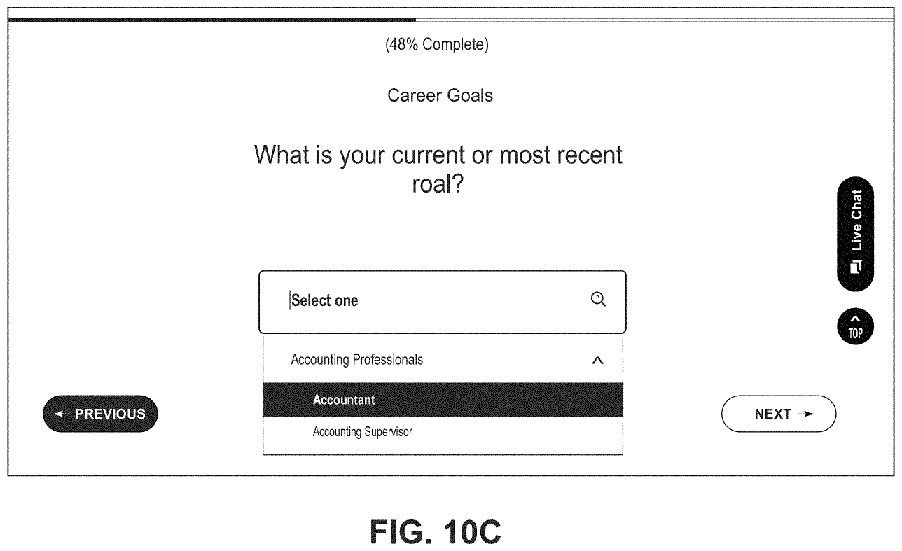

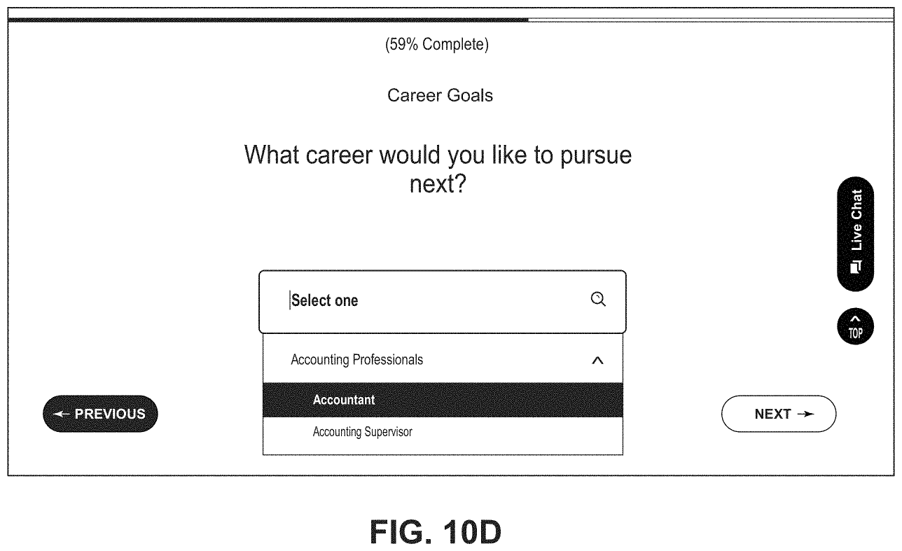

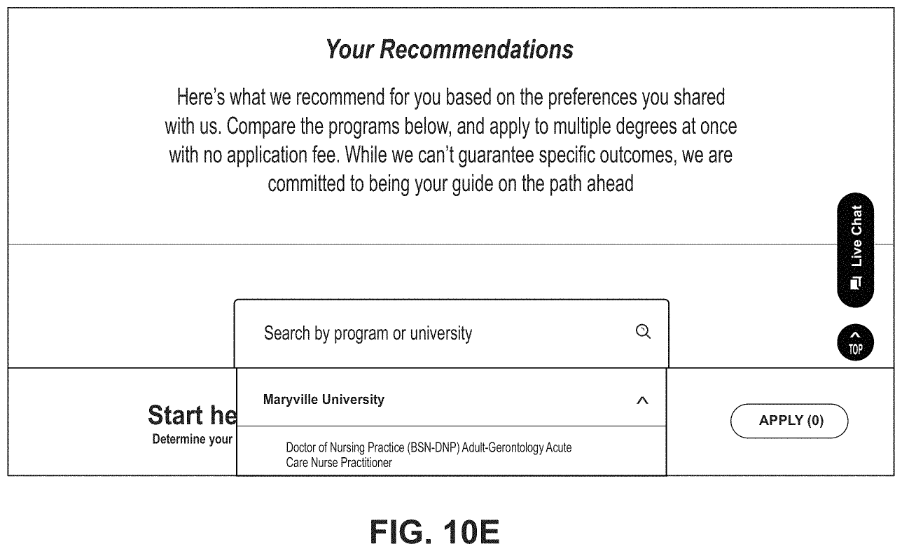

Once the mapping, model, and/or taxonomy are established in the disclosed system, a user may access the disclosed system, possibly by creating an account, navigating to the appropriate URL, and logging in, after which the user may be directed to a landing page on which a user may access the disclosed system. In some embodiments, such as those seen in FIGS. 10A-10E, the user may be provided with multiple GUIs to input responses to be used by the recommendation engine to provide recommendations for academic programs.

As seen in FIGS. 10A and 10D, the disclosed system may generate and display a GUI requesting and receiving the user's study interest and career choice. In some embodiments, the disclosed system may also receive user input indicating the purpose of these goals, possibly specifying the skills that the user is trying to grow. As seen in FIG. 10C, the disclosed system may further generate a GUI that requests additional data about the user's current career and/or role within that career. The user may input data about their current career/role, and this data may be transmitted to the server for storage and analysis. In some embodiments, the disclosed system may generate the GUI by accessing the third party taxonomy API, which may generate a GUI component for selecting from a list possible current roles.

The server may then identify, within the received data, the career and/or role identified by the user, access the stored data for the input career and/or role, and identify the skills associated with the selected career and/or role within the system and/or database. In some embodiments, the disclosed system may be configured to access a third party API which has already been populated with data about the user's current career, roles, and/or skills (e.g., LinkedIn, Indeed, Glass Door, etc.). Instead of requesting the user's current career, roles and/or skills, the disclosed embodiments may be configured to access the third party API, and download, store, and analyze the data available. Using this data, the disclosed system may extrapolate and identify, within the downloaded and stored data, the user's current career, current role within that career, listed skills, and the like.

As seen in FIGS. 10A-10E, the disclosed embodiments may include a survey of questions to determine the user's background and skills. In some embodiments, this survey of questions may be a list of pre-populated questions used to determine data about the user, and may be the same for each user that takes the survey. In these embodiments, the system may receive the responses for all users at the conclusion of the survey, and analyze them to determine details about the user, which may then be stored in database 110.

In some embodiments, the questions for each user may be personalized to that user. To accomplish this, the disclosed system may analyze each response to each question in the survey as it is received, and may determine a next question to present to the user based on the user's previous response. For example, in 10B, the user may indicate that a specific price point is an important factor in identifying a preferred academic institution. The disclosed system may provide additional questions within the survey to determine additional details about this question, or to otherwise account for the user response in a more dynamic way, uniquely aligned to the user. In some embodiments, the disclosed system may leverage artificial intelligence (AI) to make it a more intelligent algorithm, personalized to each learner.

The disclosed system may identify, within any of the data collected from the user in any of the embodiments described above, the skills associated with the user. The system may then generate a GUI listing all of the user's skills, and present this data to the user. Using this GUI, the user may confirm and/or add additional skills to the list of skills that the user currently has, allowing the user to confirm that the user has these skills, and further allowing the user to include, update, and/or delete, any of the listed skills or any additional skills that the user has, which are not listed in the list of user skills. Any updates to the user's current skills may be transmitted to server 112, and server 112 may execute necessary database commands to update the skill data associated with the user in the database 110.

Using the most up to date user skill data, the disclosed system may then compare an aggregation of all of the user's skills with the career/role skills that the user has selected as their target career or goal. The disclosed system may then automatically identify a list of skills required for the user's desired career and/or role, and automatically generate a list of skills that are required for the career/goal, which are not included in the user's most current aggregation of skills.

Using this skills gap, the disclosed system may then generate a model from the user data, and generate, using this model, an academic and/or career pathway. The system may compare the user skills and skills gap data with the skills offered by each of the stored academic institutions (e.g., degree programs). The disclosed system may then map the user to the programs for these academic institutions, identifying those programs that provide a best match that fills the void/skills gap for the user.

As demonstrated in FIG. 10B, the disclosed system may generate and present additional question to the user, specifically about user preferences. These preferences may be used by the disclosed system to filter the results of academic programs or other products presented to the user.

Once the system has determined all products, including academic programs or other career pathways that are a match for the user, the disclosed system may rank each of the results. In some embodiments, the system may determine the ranking of each of these results according to the closest match between the skills mapped to the user and the skills mapped to the academic program, career pathway, or product. In some embodiments, these results may be further weighted according to the responses to the static or dynamic questions within the user survey described above.

Although the disclosed embodiments focus on the disclosed recommendation engine, the recommendation engine could also be a part of a larger suite of products to recommend academic or career pathways for users. For example, in some embodiments, the disclosed system may include a complete package for the academic application experience from discovery to application, wherein user may have a seamless experience in which the disclosed system determines, from the information provided above, a solid match for the user's current skills and aspirations, and provide the user with all of the materials needed to not only identify the optimal program for them, but also provide access to all necessary data (e.g., transfer transcripts, job descriptions, etc.), as well as an automated application and enrollment process for applying to and enrolling in multiple programs, included in a suite of products available to the user after providing their skills and aspirational data.

In another example, the recommendation engine may be more generically applicable to users with particular skills and particular course plans, wherein a user is interested in a particular topic (e.g., astronomy).

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system comprising:
a data store server that includes a user profile data store, the user profile data store including a user profile of a user, the user profile defining a user skill set of the user;
an analytics engine coupled to the data store server and configured to:
receive a goal of the user from a user device associated with the user via electronic communication;
determine a required skill set based on the goal;
perform a comparison of the required skill set to the user skill set;
identify a skill gap between the required skill set and the user skill set based on the comparison, wherein the skill gap defines a skill of the required skill set for the user to acquire;
generate a skill training objective based on the skill gap, wherein the skill training objective corresponds to training for the skill of the skill gap;
assign the skill training objective to the user; and
a content management server coupled to the data store server and the analytics engine and configured to:
receive information corresponding to the user, the information being selected from a group consisting of: self-reported skills, manager-reported skills, skill assessment results, and historical activity of the user with respect to the system;
update the user skill set of the user based on the information;
monitor progress of the user through completion of the skill training objective via electronic communication with the user device;
generate a user interface that includes at least one metric indicative of the progress of the user;
cause the user interface to be displayed at the user device;
determine, based on the progress of the user, that the user has completed the skill training objective; and
send an alert to the user device indicating that the user has completed the skill training objective.

2. The system of claim 1, wherein a server within the system is further configured to:
execute a database command to insert, into a data store:
a plurality of academic programs; and
a plurality of skills associated in the data store with each of the plurality of academic programs;
receive a plurality of skills data associated with the user;
identify, from the plurality of skills data, the one or more skills gaps for the user, wherein the plurality of skills data do not include the plurality of skills;
generate a list of academic programs providing the plurality of skills to remove the skills gap; and
transmit the list of academic programs to the user device for display.

3. The system of claim 2, wherein the server is further configured to receive the skills data from:
an application programming interface from a third party software; or
a plurality of responses to a plurality of survey questions displayed within a survey user interface on the user device.

4. The system of claim 3, wherein the server is further configured to:
Display, on the user device, a first question in the plurality of survey questions;
receive, from the user device, a first response in the plurality of responses;
select, based on the first response, a second question in the plurality of survey questions; and
display, on the user device, the second question.

5. The system of claim 3, wherein the server is further configured to:
executing, by the processor, a database command to insert, into a data store, a plurality of additional academic program data:
receiving, by the processor from the user device, a plurality of additional responses to a plurality of academic program question; and
filtering, by the processor, the list of academic programs according to the plurality of additional responses.

6. The system of claim 2, wherein the server is further configured to identify the plurality of skills from within a taxonomy defining a plurality of skills associated with a career path or role within the career path.

7. A method comprising:
receiving, by a processor from a project profile data store, a project profile comprising definitions of roles for a project;
determining, by the processor, a plurality of required skill sets based on the definitions of the roles, wherein each role is associated with a respectively different required skill set of the plurality of required skill sets;
comparing, by the processor for a first role of the roles, user skill sets of available users to a first required skill set associated with the first role;
determining, by the processor, that a first user skill set of the user skill sets is a valid match for the first required skill set, the first user skill set being associated with a first user;
assigning, by the processor, the first user to the first role;
comparing, by the processor for a second role of the roles, the user skill sets of the available users to a second required skill set associated with the second role;
determining, by the processor, that a second user skill set of the user skill sets is a close match for the second required skill set, the second user skill set being associated with a second user;
identifying, by the processor, one or more skill gaps between the second user skill set and the second required skill set;
generating, by the processor, skill training objectives based on the one or more skill gaps;
assigning, by the processor, the skill training objectives to the second user;
monitoring progress of the second user through completion of the skill training objectives via electronic communication with a user device associated with the second user;
generating, by the processor, a user interface that includes at least one metric indicative of the progress of the second user;
causing, by the processor, the user interface to be displayed at a manager device of a manager associated with the project profile;
determining, by the processor based on the progress of the second user, that the second user has met all of the skill training objectives; and
sending, by the processor, an alert to the manager device indicating that the second user has met all of the skill training objectives.

8. The method of claim 7, further comprising the steps of:
executing, by the processor, a database command to insert, into a data store:
a plurality of academic programs; and
a plurality of skills associated in the data store with each of the plurality of academic programs;
receiving, by the processor, a plurality of skills data associated with the first user or the second user;
identifying, by the processor from the plurality of skills data, the one or more skills gaps for the first user or the second user, wherein the plurality of skills data do not include the plurality of skills;
generating, by the processor, a list of academic programs providing the plurality of skills to remove the skills gap; and
transmitting, by the processor, the list of academic programs to the user device for display.

9. The method of claim 8, further comprising the step of receiving, by the processor, the skills data from:
an application programming interface from a third party software; or
a plurality of responses to a plurality of survey questions displayed within a survey user interface on the user device.

10. The method of claim 9, further comprising the steps of:
displaying, by the processor on the user device, a first question in the plurality of survey questions;
receiving, from the user device, a first response in the plurality of responses;
selecting, by the processor based on the first response, a second question in the plurality of survey questions; and
displaying, by the processor on the user device, the second question.

11. The method of claim 9, further comprising the steps of:
executing, by the processor, a database command to insert, into a data store, a plurality of additional academic program data:
receiving, by the processor from the user device, a plurality of additional responses to a plurality of academic program question; and
filtering, by the processor, the list of academic programs according to the plurality of additional responses.

12. The method of claim 8, further comprising the step of identifying, by the processor, the plurality of skills from within a taxonomy defining a plurality of skills associated with a career path or role within the career path.

13. A system comprising a server comprising a computing device coupled to a network and comprising at least one processor executing instructions within a memory, the server being configured to:
receive, from a project profile data store, a project profile comprising definitions of roles for a project;
determine a plurality of required skill sets based on the definitions of the roles, wherein each role is associated with a respectively different required skill set of the plurality of required skill sets;
compare, for a first role of the roles, user skill sets of available users to a first required skill set associated with the first role;
determine that a first user skill set of the user skill sets is a valid match for the first required skill set, the first user skill set being associated with a first user;
assign the first user to the first role;
compare, for a second role of the roles, the user skill sets of the available users to a second required skill set associated with the second role;
determine that a second user skill set of the user skill sets is a close match for the second required skill set, the second user skill set being associated with a second user;
identify one or more skill gaps between the second user skill set and the second required skill set;
generate skill training objectives based on the one or more skill gaps;
assign the skill training objectives to the second user;
monitor progress of the second user through completion of the skill training objectives via electronic communication with a user device associated with the second user;
generate a user interface that includes at least one metric indicative of the progress of the second user;
cause the user interface to be displayed at a manager device of a manager associated with the project profile;
determine, based on the progress of the second user, that the second user has met all of the skill training objectives; and
send an alert to the manager device indicating that the second user has met all of the skill training objectives.

14. The system of claim 13, wherein the server is further configured to:
execute a database command to insert, into a data store:
a plurality of academic programs; and
a plurality of skills associated in the data store with each of the plurality of academic programs;
receive a plurality of skills data associated with the first user or the second user;
identify, from the plurality of skills data, the one or more skills gaps for the first user or the second user, wherein the plurality of skills data do not include the plurality of skills;
generate a list of academic programs providing the plurality of skills to remove the skills gap; and
transmit the list of academic programs to the user device for display.

15. The system of claim 14, wherein the server is further configured to receive the skills data from:
an application programming interface from a third party software; or
a plurality of responses to a plurality of survey questions displayed within a survey user interface on the user device.

16. The system of claim 15, wherein the server is further configured to:
display, on the user device, a first question in the plurality of survey questions;
receive a first response in the plurality of responses;
select, based on the first response, a second question in the plurality of survey questions; and
display, on the user device, the second question.

17. The system of claim 15, wherein the server is further configured to:
execute a database command to insert, into a data store, a plurality of additional academic program data:
receive, from the user device, a plurality of additional responses to a plurality of academic program question; and
filter the list of academic programs according to the plurality of additional responses.

18. The system of claim 14, wherein the server is further configured to identify the plurality of skills from within a taxonomy defining a plurality of skills associated with a career path or role within the career path.
